(19) United States
(12) Patent Application Publication
(10) Pub. No.: US 2007/0177739 A1
(43) Pub. Date: Aug. 2, 2007

(54) Method and Apparatus for Distributed Data Replication

(75) Inventors: Samrat Ganguly, Monmouth Junction, NJ (US); Aniruddha Bohra, Edison, NJ (US); Rauf Izmailov, Plainsboro, NJ (US); Yoshihide Kikuchi, Princeton, NJ (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/275,764

(22) Filed: Jan. 27, 2006

(51) Int. Cl. H04L 9/00

(52) U.S. Cl. 380/277

(57) ABSTRACT

Disclosed is a data replication technique for providing erasure encoded replication of large data sets over a geographically distributed replica set. The technique utilizes a multicast tree to store, forward, and erasure encode the data set. The erasure encoding of data may be performed at various locations within the multicast tree, including the source, intermediate nodes, and destination nodes. In one embodiment, the system comprises a source node for storing the original data set, a plurality of intermediate nodes, and a plurality of leaf nodes for storing the unique replica fragments. The nodes are configured as a multicast tree to convert the original data into the unique replica fragments by performing distributed erasure encoding at a plurality of levels of the multicast tree.

### BACKGROUND OF THE INVENTION

The present invention relates generally to data replication, and more particularly to distributed data replication using a multicast tree.

Periodic backup and archival of electronic data is an important part of many computer systems. For many companies, the availability and accuracy of their computer system data is critical to their continued operations. As such, there are many systems in place to periodically backup and archive critical data. It has become apparent that simply backing up data at the location of the main computer system is an insufficient disaster recovery mechanism. If a disaster (e.g., fire, flood, etc.) strikes the location where the main computer system is located, any backup media (e.g., tapes, disks, etc.) are likely to be destroyed along with the original data. In recognition of this problem, many companies now use off-site backup techniques, whereby critical data is backed up to an off-site computer system, such that critical data may be stored on media that is located at a distant geographic location. In order to provide additional protection, the data is often replicated at multiple backup sites, so that the original data may be recovered in the event of a failure of one or more of the backup sites. Off-site backup generally requires that the replicated data be transmitted over a network to the backup sites.

As data sets increase in size, replication and storage becomes a problem. There are two main problems with replication of large data sets. First, replication creates a bandwidth bottleneck at the source since multiple copies of the same data are transmitted over the network. This problem is illustrated in FIG. 1, which shows a prior art data replication technique in which a source node 102, which is the source of the original data set to be backed up (represented by 116), backs up data to four replica nodes 104, 106, 108, 110 via network 112. In order to replicate the original data set 116 at each of the replica nodes 104, 106, 108 and 110, the source transmits the original data 116 set to each of the replica nodes via network 112. If the original data set is large, for example 4 terabytes, then the source must transmit 4 terabytes, four separate times, to each of the replica nodes, for a total transmission of 16 terabytes. The transmission of 16 terabytes from the source 102 creates a significant bandwidth bottleneck at the source's connection to the network, as represented by 114. Another problem with the replication technique illustrated in FIG. 1 is that each of the replica nodes 104, 106, 108, 110 must store the entire 4 terabytes of the backup data set.

One known solution to the problem illustrated in FIG. 1 is to use network nodes logically organized as a multicast tree, as shown in FIG. 2. FIG. 2 shows source node 202, which is the source of the original data set (represented by 216) to be backed up, and four replica nodes 204, 206, 208, 210. In this solution, the bottleneck (114 FIG. 1) is reduced by using multicast techniques to transport the backup data 216 to replica nodes 204, 206, 208, 210 using intermediate nodes 212 and 214. Here, the source node 202 transmits the replicated data 216 to intermediate nodes 212 and 214. Intermediate node 212 then transmits the replicated data 216 to replica nodes 204 and 206. Intermediate node 214 transmits the replicated data 216 to replica nodes 208 and 210. Here the bandwidth requirement at the source node 202 has been reduced by 50%, as now the source node 202 only needs to transmit two replica data sets, for a total of 8 terabytes. While the multicast technique shown in FIG. 2 reduces the forward load on the source 202, the problem of storage requirements at the replica nodes is not alleviated, as each of the replica nodes 204, 206, 208, 210 still must store the entire 4 terabytes of the backup data set.

One solution to the storage requirements of the replica nodes is the use of erasure encoding. An erasure code provides redundancy without the overhead of strict replication. Erasure codes divide an original data set into n blocks and encodes them into l encoded fragments, where l>n. The rate of encoding r is defined as

$$r = \frac{l}{m} < 1.$$

The key property of erasure codes is that the original data set can be reconstructed from any l encoded fragments. The benefit of the use of erasure encoding is that each of the replica nodes only needs to store one of the m encoded fragments, which has a size significantly smaller than the original data set. Erasure encoding is well known in the art, and further details of erasure encoding may be found in John Byers, Michael Luby, Michael Mitzenmacher, and Ashu Rege, “A Digital Fountain Approach to Reliable Distribution of Bulk Data”, Proceedings of ACM SIGCOMM '98, Vancouver, Canada, September 1998, pp. 56-67, which is incorporated herein by reference. This use of erasure encoding to back up original data over a network is illustrated in FIG. 3. FIG. 3, shows a prior art data replication technique in which a source node 302, which is the source of the original data set (represented by 316) to be backed up, backs up data to four replica nodes 304, 306, 308, 310 via network 312 using erasure encoding. Here, prior to transmitting the replicated data, the source node 316 performs erasure encoding to generate four erasure encoded fragments 318, 320, 322, 324. The source transmits the four erasure encoded fragments to each of the replica nodes via network 312. One property of erasure codes is that the aggregate size of the n encoded fragments is larger than the size of the original data set. Thus, the problem of bandwidth bottleneck described above in connection with FIG. 1 is even worse in this case because of the aggregate size of the encoded fragments. The transmission of the encoded fragments from the source 102 creates a significant bandwidth bottleneck at the source's connection to the network, as represented by 314.

Unfortunately, the multicast technique illustrated in FIG. 2, which partially alleviates the bandwidth bottleneck problem illustrated in FIG. 1, cannot be used to alleviate the bandwidth bottleneck problem illustrated in FIG. 3. This is due to the fact that each erasure encoded fragment 318, 320, 322, 324 must be unique and linearly independent of all other fragments. Whereas in the multicast technique of FIG. 2, each of the intermediate nodes 212, 214 forwards identical data (replicated data 216) to the replica nodes, such is not the case when using erasure encoding. As shown in FIG. 3, each of the erasure encoded fragments 318, 320, 322 324 are unique, and as such the multicast technique of FIG. 2 cannot be used with a data replication technique based on erasure encoding. Thus, existing techniques rely on a single node (e.g., the source) to generate the entire erasure encoded data set, and disseminate it using multiple unicasts to the replica nodes.

What is needed is an improved data replication technique which solves the above described problems.

### BRIEF SUMMARY OF THE INVENTION

The present invention provides an improved data replication technique by providing erasure encoded replication of large data sets over a geographically distributed replica set. The invention utilizes a multicast tree to store, forward, and erasure encode the data set. The erasure encoding of data may be performed at various locations within the multicast tree, including the source, intermediate nodes, and destination nodes. By distributing the erasure encoding over nodes of the multicast tree, the present invention solves many of the problems of the prior art discussed above.

In accordance with an embodiment of the invention, a system converts original data into a replica set comprising a plurality of unique replica fragments. The system comprises a source node for storing the original data set, a plurality of intermediate nodes, and a plurality of leaf nodes for storing the unique replica fragments. The nodes are configured as a multicast tree to convert the original data into the unique replica fragments by performing distributed erasure encoding at a plurality of levels of the multicast tree.

In one embodiment, original data is converted into a replica data set comprising a plurality of unique replica fragments. First level encoding is performed by encoding the original data at one or more network nodes to generate intermediate encoded data. The intermediate encoded data is transmitted to other network nodes which then perform second level encoding of the intermediate encoded data. The second level encoding may generate the unique replica fragments, or it may generate further intermediate encoded data for further encoding. In one embodiment, the network nodes performing the data encoding and storage of the replica fragments are organized as a multicast tree.

In another embodiment, a multicast tree of network nodes is used to convert original data into a replica set comprising a plurality of unique replica fragments. First level encoding is performed by encoding the original data at at least one first level network node to generate at least one first level intermediate encoded data block. Then, for each of a plurality of further encoding levels (n), performing n^{th} level encoding of at least one n-1 level intermediate encoded data block at at least one n^{th} level network node in the multicast tree to generate at least one n^{th} level intermediate encoded data block. At a final encoding level, final level encoding is performed on at least one n-1 level intermediate encoded data block to generate at least one unique replica fragment. The unique replica fragments may be stored at leaf nodes of the multicast tree.

In advantageous embodiments, the encoding described above is erasure encoding.

These and other advantages of the invention will be apparent to those of ordinary skill in the art by reference to the following detailed description and the accompanying drawings.

### BRIEF DESCRIPTION OF THE DRAWINGS

FIG. 1 shows a prior art data replication technique;

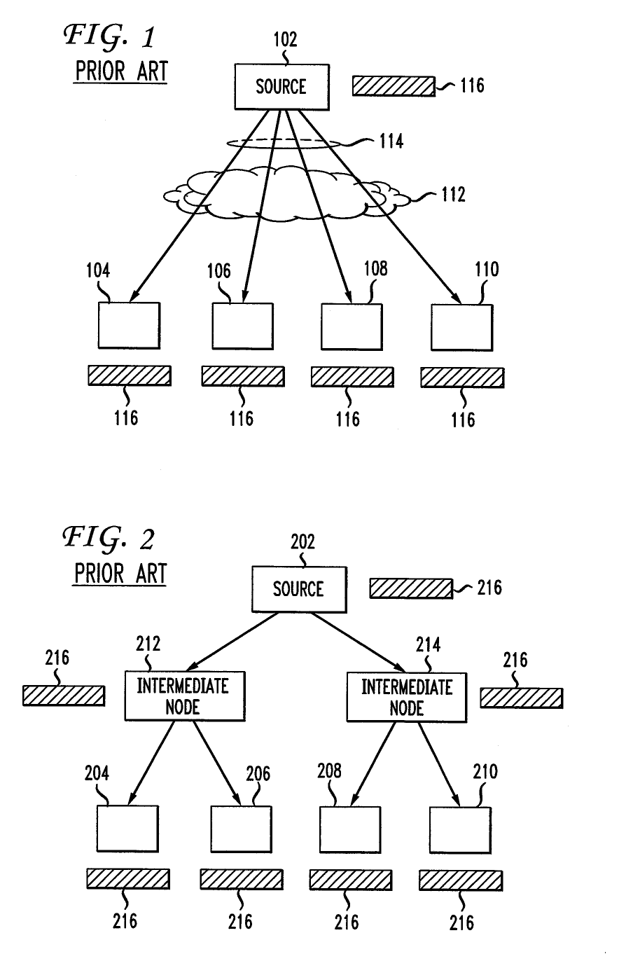

FIG. 2 shows prior art network nodes logically organized as a multicast tree;

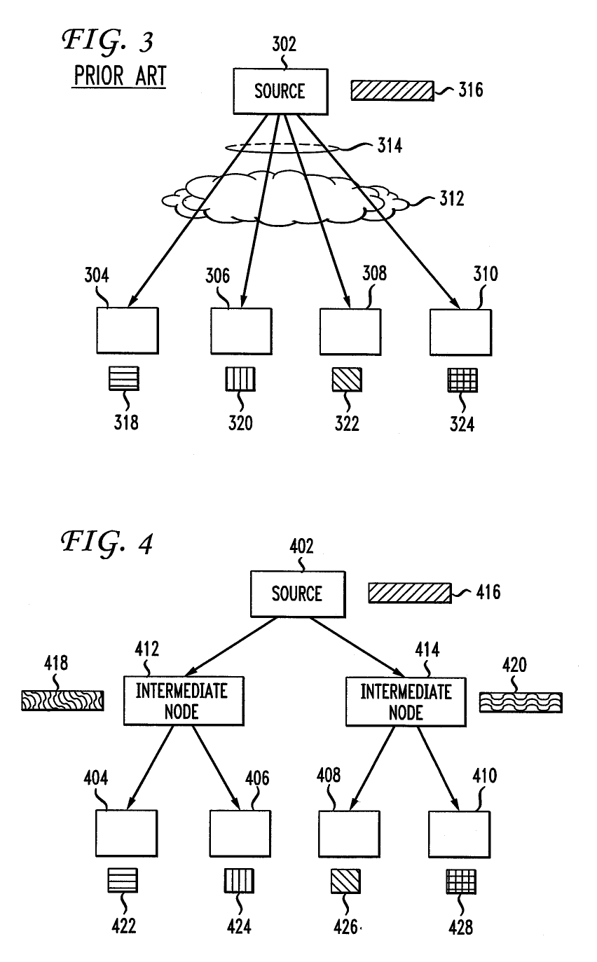

FIG. 3 show a prior art technique of erasure encoding to back up original data over network;

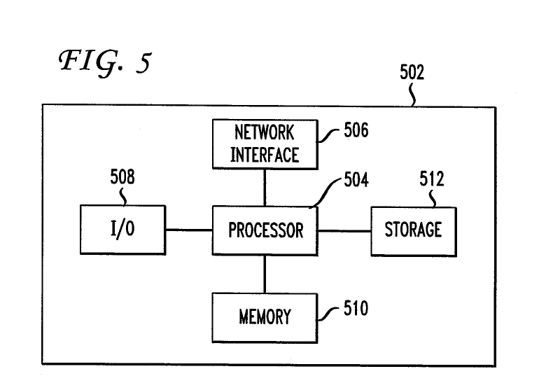

FIG. 4 illustrates the use of a multicast tree of distributed network nodes to convert original data into a replica data set comprising a number of unique replica fragments;

FIG. 5 shows a high level block diagram of a computer which may be used to implement network nodes;

FIG. 6 shows a block diagram illustrating an embodiment of the present invention;

FIGS. 7-10 are flowcharts illustrating a technique for creating a multicast tree;

FIG. 11 is a flowchart illustrating a technique for performing erasure encoding within a multicast tree; and

FIG. 12 illustrates erasure encoding in a multicast tree.

### DETAILED DESCRIPTION

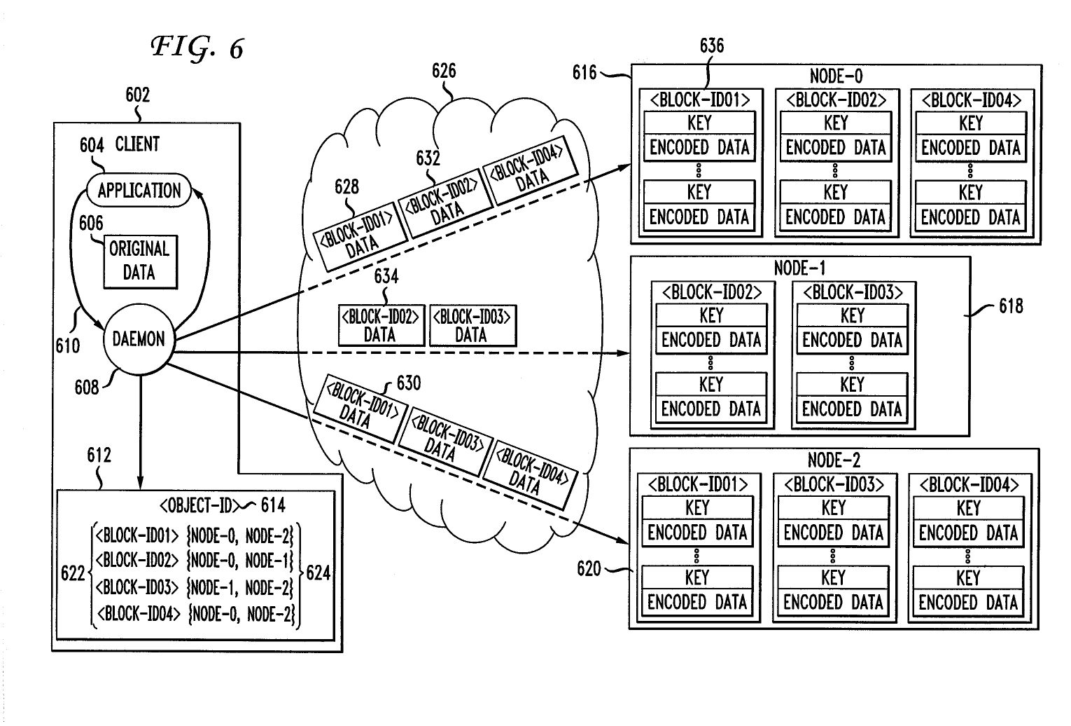

FIG. 4 shows a high level illustration of the principles of the present invention for converting original data into a replica data set comprising a number of unique replica fragments using a multicast tree of distributed network nodes. Source node 402 contains original data 416 to be replicated and stored at the replica nodes 404, 406, 408, 410. The source node 402 transmits a portion of the original data 416 to intermediate nodes 412 and 420. Each of the intermediate nodes performs a first level erasure encoding by encoding its received portion of original data to generate first level intermediate erasure encoded data blocks. More particularly, intermediate node 412 erasure encodes its portion of the original data to generate intermediate erasure encoded data block 418. Intermediate node 414 erasure encodes its portion of the original data to generate intermediate erasure encoded data block 420. Intermediate node 412 transmits intermediate erasure encoded data block 418 to replica nodes 404 and 406, and intermediate node 414 transmits intermediate erasure encoded data block 420 to replica nodes 408 and 410. Each of the replica nodes 404, 406, 408, 410 further erasure encodes its received intermediate erasure encoded data block to generate a unique replica fragment, which is then stored in the replica node. More particularly, replica node 404 further erasure encodes intermediate erasure encoded data block 418 into replica fragment 422. Replica node 406 further erasure encodes intermediate erasure encoded data block 418 into replica fragment 424. Replica node 408 further erasure encodes intermediate erasure encoded data block 420 into replica fragment 426. Replica node 410 further erasure encodes intermediate erasure encoded data block 420 into replica fragment 428. In accordance with the principles of erasure encoding, some number of replica set fragments 422, 424, 426, 428 may be used to reconstruct the original data set 416.

As can be seen from FIG. 4, a system in accordance with the principles of the present invention solves the problems of the prior art. First, the bandwidth bottleneck problem of the prior art is solved because multicast forwarding is used to reduce the forward load of the network nodes. For example, even though there are four replica nodes 404, 406, 408, 410, source node 402 only transmits portions of the original data to the intermediate nodes 412, 414. Second, the storage space problem of the prior art is solved because each of the replica nodes only stores replica set fragments, and there is no need for a replica node to store the entire original data set. Thus, by distributing the erasure encoding task among the nodes in a multicast tree, the present invention provides an improved technique for converting original data into a replica set of unique replica fragments.

It is to be recognized that FIG. 4 is a simplified network diagram used to illustrate the present invention, and that various alternative embodiments are possible. For example, while only two levels of erasure encoding are shown, additional levels of erasure encoding may be implemented within the multicast tree. Further, the multicast tree need not be balanced. For example, replica fragment 422 stored at replica node 404 may be the result of two levels of erasure encoding, while replica fragment 428 stored at replica node 410 may be the result of three or more levels of erasure encoding. In addition, while FIG. 4 shows source node 402 transmitting portions of the original data set to intermediate nodes 412 and 414, in alternate embodiments, source node 402 itself may perform the first level erasure encoding, and therefore transmit intermediate erasure encoded data blocks to intermediate nodes 412 and 414. Further, while FIG. 4 shows the replica nodes performing the final level of erasure encoding to generate the replica fragments, such final level erasure encoding may be performed at an intermediate node, and the replica fragments may be transmitted to the replica nodes for storage, without the replica nodes themselves performing any erasure encoding. Further, some of the nodes in the multicast tree may not perform erasure encoding. All nodes in the multicast tree will provide at least store and forward functionality, and may additionally provide erasure encoding functionality. One important characteristic is that the erasure encoding can be performed anywhere in the multicast tree: the source, the intermediate nodes, or the replica leaf nodes. It will be apparent to one skilled in the art from the description herein, that various combinations and alternatives may be applied to the system generally shown in FIG. 4 in order to convert original data into a replica data set using a multicast tree of distributed network nodes in accordance with the principles of the present invention.

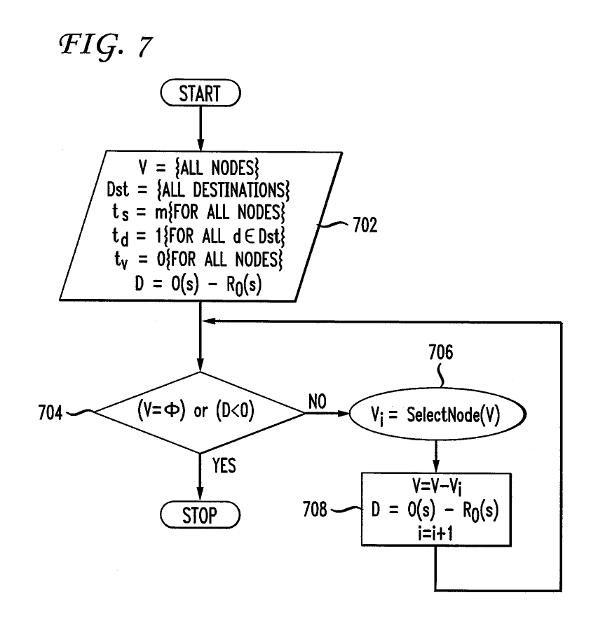

The description above, and the description that follows herein, provides a functional description of various embodiments of the present invention. One skilled in the art will recognize that the functionality of the network nodes and computers described herein may be implemented, for example, using well known computer processors, memory units, storage devices, computer software, and other components. A high level block diagram of such a computer is shown in FIG. 5. Computer 502 contains a processor 504 which controls the overall operation of computer 502 by executing computer program instructions which define such operation. The computer program instructions may be stored in a storage device 512 (e.g., magnetic disk) and loaded into memory 510 when execution of the computer program instructions is desired. Thus, the operation of the computer will be defined by computer program instructions stored in memory 510 and/or storage 512 and the computer functionality will be controlled by processor 504 executing the computer program instructions. Computer 502 also includes one or more network interfaces 506 for communicating with other nodes via a network. Computer 502 also includes input/output 508 which represents devices which allow for user interaction with the computer 502 (e.g., display, keyboard, mouse, speakers, buttons, etc.). One skilled in the art will recognize that an implementation of an actual computer will contain other components as well, and that FIG. 5 is a high level representation of some of the components of such a computer for illustrative purposes.

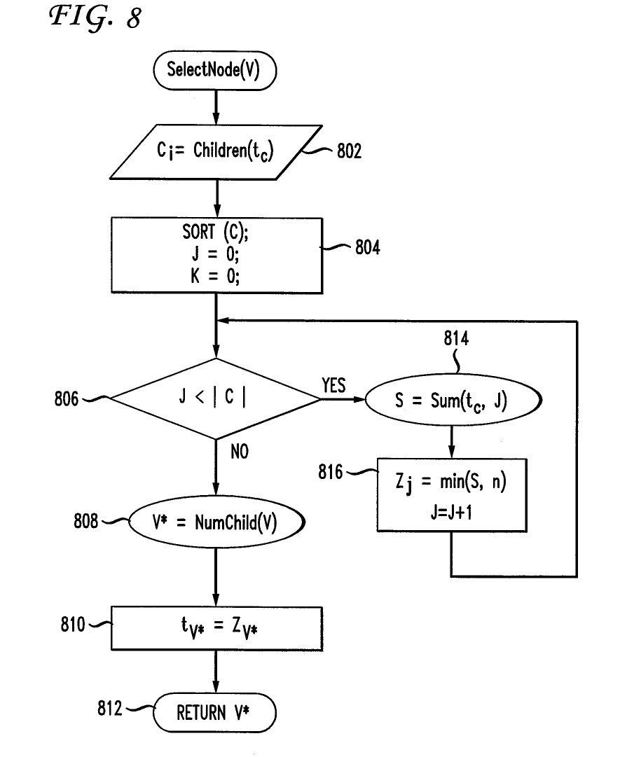

An embodiment of the invention will now be described in conjunction with FIGS. 6-12. FIG. 6 shows a client node 602 executing an application 604. Application 604 may be any type of application executing on client node 602. As described above in the background, an application may want to replicate data for storage on remote nodes. Assume that application 604 has identified some original data 606 that application 604 wants replicated and stored on remote nodes. In the embodiment shown in FIG. 6, the link to the replication system is through a daemon 608 executing on client 602. Applications, such as application 604, interact with the replication system through daemon 608. For example, this interaction may be through the use of an application programming interface (API). In one embodiment, the application 604 may indicate that data is to be replicated using the following API call:
create_object (objname, buf, len, &objmeta), where:
   objname is a name provided by the application to identify the object;
   buf is a pointer to the memory location in the client 602 at which the original data is located;
   len is the length of the data stored starting at buf;
   &objmeta is the memory address of the object metadata created by the daemon, as described in further detail below.
      Thus, when application 604 wants to replica data, it sends the above described API call to the daemon 608 as represented in FIG. 6 by 610. Upon receipt of the API call 610, the daemon will create object metadata 612 as follows.

The objname is used to create the OBJECT-ID 614 using a collision resistant cryptographic hash, for example as described in K. Fu, M. F. Kaashoek, and D. Mazieres, Fast and Secure Distributed Read-Only File System, in ACM Trans. Comput. Syst., 20(1):1-24, 2002. The OBJECT-ID 614 is a unique identifier used by the replication system in order to identify the metadata. Next, the daemon 608 breaks up the original data 606 into fixed sized blocks of data, and assigns each such block an identifier. The size of the block is a tradeoff between encoding overhead (which increases linearly with block size) and network bandwidth usage. Appropriate block size will vary with different implementations. In the current embodiment, we assume the size of 2048 bytes. The block identifier may be assigned by hashing the contents of the block. Assuming four blocks of data for the example shown in FIG. 6, the four identifiers are represented as:
<BLOCKID01>
<BLOCKID02>
<BLOCKID03>
<BLOCKID04>
   These block identifiers are stored in the metadata 612 as shown at 622. After assigning and identifying the data blocks, the daemon 608 will assign the replica nodes upon which the ultimate replica data set (i.e., the replica fragments) will be stored. In the example, of FIG. 6, assume that there are three replica nodes 616, 618, 620 which will store the replica fragments. The daemon 608 chooses which data blocks will be stored at which replica node and stores the identifications in the metadata 612 as shown as 624. As shown in FIG. 6, the replica fragments associated with the block identified by BLOCKID01 will be stored at replica nodes 0 and 2, the replica fragments associated with the block identified by BLOCKID02 will be stored at replica nodes 0 and 1, the replica fragments associated with the block identified by BLOCKID03 will be stored at replica nodes 1 and 2, and the replica fragments associated with the block identified by BLOCKID04 will be stored at replica nodes 0 and 2.

The number of nodes in the replica node set is determined based upon the availability and performance requirement of the replication application. For example, a data center which performs backups for a large corporation may require high failure resilience which would require a large replica node set.

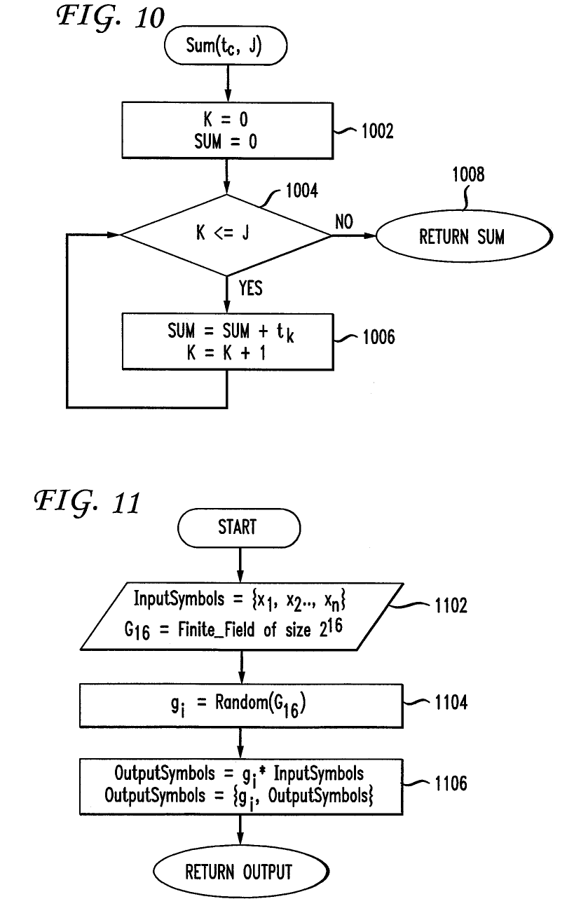

At this point, the object metadata 612 is complete, and each data block is assigned to one or more replica nodes. Next, the daemon 608 transmits each block of data to its assigned replica node via the multicast tree 626. This transmission of data blocks to their respective replica nodes is shown in FIG. 6. For example, FIG. 6 shows data 628 comprising the <BLOCKID01> identifier and the actual data associated with identifier <BLOCKID01> being sent to node-0 616. Data 630 comprising <BLOCKID01> identifier and the actual data associated with identifier <BLOCKID01> is shown being sent to node-2 620. Data 632 comprising <BLOCKID02> identifier and the actual data associated with identifier <BLOCKID02> is shown being sent to node-0 616. Data 634 comprising <BLOCKID02> identifier and the actual data associated with identifier <BLOCKID02> is shown being sent to node-1 618. FIG. 6 shows in a similar manner the identifiers and associated data for <BLOCKID03> and <BLOCKID04> being sent to their respective replica nodes. As the data traverses the multicast tree, the data is erasure encoded in a distributed manner at various nodes in the tree as described above in connection with FIG. 4. As described above, it is to be understood that the first level encoding could take place within the multicast tree 626, or it may take place within the daemon 608. Further, the final level encoding could take place at intermediate nodes within the multicast tree 626, or it may take place within the replica (leaf) nodes 616, 618, 620. Although not represented as such in FIG. 6, the client 602 and replica nodes 616, 618, 620 are logically elements of the multicast tree 626. Further details of the multicast encoding will be described below in connection with FIG. 11.

The result of the erasure encoding will be replica fragments stored at each of the replica nodes. The fragments are an erasure encoded representation of a fixed sized chunk of the original data. At the replica nodes, the replica fragments are stored indexed by the block identifier. In addition to the erasure encoded data, each fragment also includes the encoding key used to encode the data (as described in further detail below). This makes each fragment self-contained, and an entire block of data may be decoded upon retrieval of the necessary fragments. The stored fragments are shown in FIG. 6. For example, fragment 636 is shown indexed by block identifier <BLOCKID01>. Fragment 636 contains a key and encoded data. Fragments 636 is shown stored in node-0 616. The other fragments are shown in FIG. 6 as well.

After all fragments are stored at their respective replica nodes, the daemon 608 returns the location in memory of the object metadata 622 to the application 604. This may be as the result of a return from the API call with the address &objmeta. At this point, the original data 606 is backed up to a replica data set comprising a plurality of unique replica fragments stored at the replica nodes.

Data retrieval may be implemented by the application 604 at any time after the replica data set is stored at the replica nodes. For example, an event relating in loss of the original data 606 at the client 602 may result in the application 604 requesting a retrieval of the replicated data stored on the replica nodes. In one embodiment, data retrieval is performed on a per-block basis, and the application 604 may indicate the data block to be retrieved using the following API call:
read_block (BlockID, & but,& &len), where:
   BlockID is the identifier of the particular block to be retrieved;
   &buf is the address in memory storing a pointer to the memory location at which the block is to be stored;
   &len is the address in memory storing the length of the data block.
      Thus, when application 604 wants to retrieve a data block, it sends the above described API call to the daemon 608. Based on the BlockID in the request, the daemon 608 determines the replica nodes at which an encoded version of that block is stored by accessing the object metadata 612. The daemon then retrieves the fragments associated with the identified block from the replica node and decodes the fragments to reconstruct the original data block. The restored data block is stored in memory and the daemon 608 returns a pointer to the memory location at which the block is stored in a memory location identified by &buf. The daemon 608 returns the address in memory storing the length of the data block in &len. In this manner, the application 604 can reconstruct the entire original data 606. It is noted that the above described embodiment describes a technique whereby the application 604 uses a block-by-block technique to reconstruct the original data 606. In alternate embodiments, the entire original data set could be restored using a single API call in which the application provides the OBJECT-ID to the daemon 608 and the daemon 608 automatically retrieves all of the associated data blocks.

When the application 604 no longer needs the replica data sets to be stored on the replica nodes, the application 604 may send an appropriate command to the daemon 608 with instructions to destroy the stored replica data set. In one embodiment, the application 604 may indicate that the replica data set is to be destroyed using the following API call:
destroy_object (objmeta), where:
   objmeta is memory address of the object metadata.
      Upon receipt of this instruction, the daemon 608 will access the metadata 622 and will send appropriate commands to the replica nodes at which the encoded fragments are stored, instructing the replica nodes to destroy the fragments.

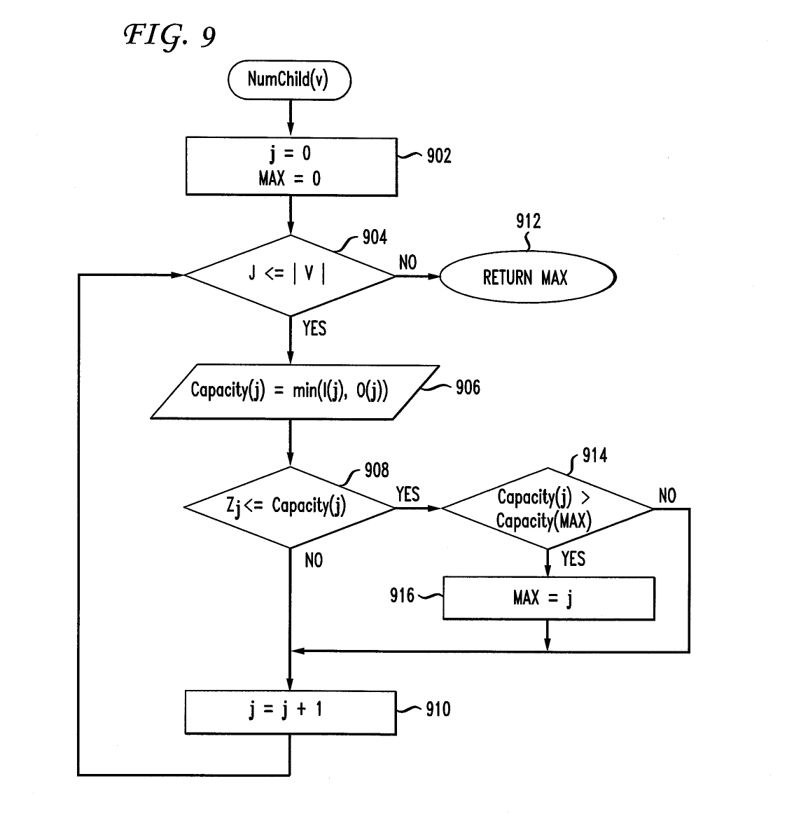

Further details of the erasure encoding using a multicast tree, in accordance with an embodiment of the present invention, will now be provided. First, a technique for creating the multicast tree will be described in conjunction with FIGS. 7-10 Second, a technique for performing the erasure encoding within the multicast tree will be described in conjunction with FIG. 11.

As described above, upon receipt of a create_object (objname, buf, len, &objmeta) instruction by the daemon 608, the multicast tree 626 must be defined. An optimized tree can be created where the amount of information flow into and out of a given intermediate node best matches the incoming and outgoing node capacity. Assume that we have a set of nodes V which are willing to cooperate in the distribution process. Each node vεV specifies a capacity budget for incoming (bᵢₙ(v)) and outgoing (bₒᵤₜ(v)) access to v. These capacities are mapped to integer capacity units using the minimum value (bₘin) among all incoming and outgoing capacities. For a node v, the incoming capacity is I(v)=└bᵢₙ(v)/bₘᵢₙ┘ and outgoing capacity is O(vⱼ)=└bₒᵤₜ(v)/bₘᵢₙ┘. Each unit capacity corresponds to transferring u=l/m symbols per unit time. Using the degree (sum of maximum incoming and outgoing symbols at a node) information, the goal is to construct a distribution tree which keeps the number of symbols on each edge within its capacity.

The creation of the multicast tree will be described in connection with the flowcharts of FIGS. 7-10. Step 702 shows an initialization step. For each node v in the tree, we maintain a value tᵥ which represents the number of destinations in the sub-tree rooted at v. For the source node s, The value of tₛ is always m (the total number of destinations). The value of t_{d} for all destinations dεD is always 1. Initially we connect the source s to all m destinations directly. If O(s)>1 then the source can support the destinations directly and no intermediate nodes are required in the tree. Otherwise, we need to add intermediate nodes to reduce the burden on the source. To facilitate identification of overloaded nodes, we define D as O(s)−Rₒ(s) where Rₒ(v) is the number of symbols going out of v. The tree construction algorithm aims at minimizing D if it is negative (i.e., if s is overloaded).

Suppose that D is negative, which indicates that the source is overloaded. We need to find a node vεV which can take some load off s. The two key questions here are: 1) which node among V is selected for the purpose and 2) which of the source's children it takes over. In step 704 it is determined whether V=φ (i.e., the set of available nodes is null) and D<0 (i.e., the source is overloaded). If yes, then the algorithm ends. If the test in step 704 is no, then in step 706, the algorithm selects the node vᵢ (using function Select-Node) which can take over the maximum number of the source's children. This node is the one which has both incoming and outgoing capacities that can support the flow of the maximum number of symbols (determined using the value of tᵢ for all of the source's children i). Further details of the SelectNode function will be described below in conjunction with FIG. 8. After vᵢ is selected in step 706, then in step 708 the node vᵢ selected in step 706 is removed from the available set of nodes V, D is recalculated as described above, and i is incremented by 1. The algorithm passes control to the test of step 704 until it has reduced the load on the source below its acceptable limits or if there are no further intermediate nodes left.

The details of the SelectNode function (step 706) are shown in the flowchart of FIG. 8. On entering the SelectNode function, in step 802 the candidate set for the child node (C) is initialized as the set of all children of the input vertex V. In step 804 the set is sorted in decreasing order of coverage using the coverage (t_{c}) as the key. Any well known sorting procedure may be used. Steps 806, 814, 816 form a loop which uses an index J to iterate over the set C (|C| is the size of the set C). Therefore, for each element in C, the sum of the coverage (tⱼ) of all children of this node (J) is calculated. This calculation is discussed in further details below in conjunction with FIG. 10. In step 816, the coverage for each J (Zⱼ) is assigned to the minimum of the sum calculated in step 814 and the maximum number of symbols (n). Once the iteration condition in step 806 is not satisfied, control passes to step 808, where a function to calculate the index of the vertex to be selected is called. This function is described below in conjunction with the flowchart of FIG. 9. The new coverage value t_{v*}for the chosen node is updated in step 810. The vertex returned by the function NumChild is returned to the caller in step 812.

The details of the NumChild function (step 808) are shown in the flowchart of FIG. 9. The goal of the NumChild function is to find the index of the vertex which has the maximum capacity (number of incoming and outgoing symbols it can support). The index with the maximum capacity (MAX) and the iteration index (j) are initialized in step 902. j creates a loop over the set of vertices (V). The loop condition is tested in step 904 and is continued in step 910. If the loop has not completed, control passes to step 906 where the capacity is initialized as the minimum of incoming and outgoing symbols at the node (j). If the desired coverage Zⱼ (as calculated in step 816) is less than or equal to the capacity of the node under consideration (j) (as tested in step 908), then control passes to step 914 as this node is a candidate. In step 914, the capacity is compared against the capacity of the current maximum. If the capacity is greater, the index of the maximum capacity node (MAX) is set to j in step 916. The loop is terminated at step 912, where the index of the maximum capacity node is returned.

FIG. 10 shows a flowchart of the steps performed to calculate the sum of coverage values of all the children of the node under consideration (J) from step 814. In step 1002 K and SUM are initialized to zero. In step 1004 it is determined whether K<=J. If yes, then in step 1006 tₖ is added to the value of SUM, K is incremented by 1, and control is passed to step 1004. When the test of step 1004 is no, the value of SUM is returned in step 1008.

The algorithm for erasure encoding, using the multicast tree defined in accordance with the above algorithm, will now be described in conjunction with FIG. 11. Generally, to generated erasure encoded data, a given block is split into n equal sized fragments, which are then encoded into l fragments where l>n. As represented in step 1102, consider x₁,x₂, . . . , xᵢ, . . . xₙ to be the input symbols representing the jth byte of n original fragments. Random coefficients are generated for a given field size (2¹⁶ in the current embodiment) as shown in step 1104. The encoded output symbols yₗ, . . . , yₗare constructed by taking linear combination of the input symbols xᵢ over a large finite field in step 1106. The ratio r of the number of output symbols to the number of input symbols is called the stretch factor of erasure coding

$$( r = \frac{l}{m} ) .$$

If r>1, any n symbols can be chosen to reconstruct the original data. For the data to be available even in presence of failures, we equally distribute the l fragments corresponding to the l symbols over the m systems. Our goal is to enable retrieval of any n fragments in the presence of k failures. It can be demonstrated that the original data block can be reconstructed with high probability from any k nodes from the replica set if

$$k \times \frac{l}{m} > n .$$

The linear transformation of the original data can be represented as Y=g₁x₁+g₂x₂+ . . . +gₙxₙ, or
y=GX^{T} (1)
where G is the encoding coefficient vector, and X^{T} is the transpose of the vector X=[x₁x₂. . . , xₙ]. In order to reconstruct the original symbols xᵢ, at least n encoded symbols (Yᵢs) are required if the equations represented by (yᵢs) are linearly independent. This also implies that the output symbols must be distinct for reconstruction.

As described above, in accordance with an embodiment of the invention, erasure encoded data fragments are distributed over a multicast tree. The goal of distribution using a multicast tree is to have the rate or forwarding load at each node as low as possible, where each intermediate node in the tree participates in the encoding process. Each node receives a set of j input symbols x₁, . . . xⱼ and generates h linearly independent output symbols y₁ . . . yₕ, along each outgoing edge. The linear independence is ensured with very high probability (1-2⁻¹⁶) by randomly selecting the encoding coefficients which lie in a finite field of sufficient size (2¹⁶) to generate y. This technique is described in R. Koetter and M. Médard, “An algebraic approach to network coding,” IEEE/ACM Trans. Networking, vol. 11, pp. 782-795, October 2003.

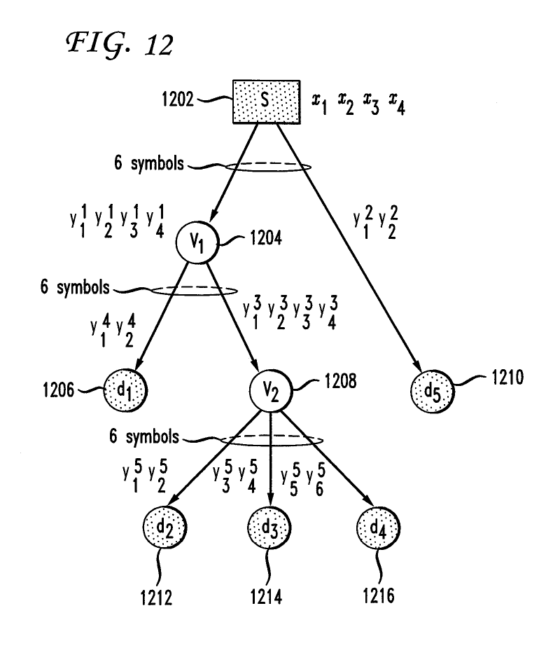

Instead of generating the complete set of output encoded symbols at the source, encoding in accordance with the principles of the present invention encodes in stages, where each intermediate node creates additional symbols as necessary based on the information it receives. The example shown in FIG. 12 illustrates this approach, with n=4 and l=10. As shown in FIG. 12, a multicast tree is used where both the intermediate nodes (1204, 1208) along with the source node (1202) perform partial encoding to generate the l=10 output symbols at the destination (leaf) nodes (1206, 1210, 1212, 1214, 1216).

Encoding by intermediate nodes in a path from the source to the destination (leaf of the tree) results in repeated transformations of the original symbols. Therefore, the output symbol at a destination as given in equation (1) becomes
y=GₙGₙ₋₁ . . . G₁X^{T} (2)
y=G_{f}X^{T} (3)
In order to decode, the polynomial G_{f} (i.e., the key) is included with each fragment generated in the system. These keys were described above in conjunction with FIG. 6.

Consider replication of a block of data with a redundancy factor of k. For the multicast tree used for distribution T, the source S denotes the root of the tree, V is the set of intermediate nodes and the set of destination nodes D are the leaf nodes. We define coverage t(v), for each intermediate node vεV as the number of leaf nodes covered by it. At the end of the data transfer, each destination node must receive its share of l/m symbols. Therefore, any intermediate node must forward enough symbols for each of its children. Moreover, the assumption of linear independence requires that if the number of children of a node is greater than the redundancy factor, the node must be able to reconstruct the original data. Therefore, the number of input symbols received by each node in the system is given by.

$$\begin{matrix}i n ( v ) \geq n & t ( v ) \geq k \\ \geq k \times \frac{l}{m} & t ( v ) < k\end{matrix} \qquad ( 4 )$$

where k is the redundancy factor of the encoding.

Starting from the leaf nodes and going up the tree towards the root, Equation 4 is applied to determine the number of symbols flowing through each edge of the multicast tree.

As would be recognized by one skilled in the art, in designing an actual implementation of a system in accordance with the principles of the present invention, various implementation design issues will arise. For example, one such design issue relates to failures and deadlocks. Various known techniques for deadlock avoidance and for handling node failures may be utilized in conjunction with a system in accordance with the principles of the present invention. For example, the techniques described in M. Castro et al., SplitStream: High-Bandwidth Multicast in Cooperative Environments, in Proceedings of the 19ₜₕ ACM Symposium on Operating Systems Principles, pages 298-313, October 2003, may be utilized. SplitStream passes the responsibility of using appropriate timeouts and retransmissions to handle failures.

Another design issue relates to replica reconstruction. As described above, the encoded fragments are anonymous. There are two main reasons for this. First, the number of fragments depends on the degree of redundancy chosen by the application. A large number of fragments can therefore exist for each block leading to a large increase in the DHT size and routing tables. Second, the fragments can be reconstructed in a new incarnation of a replica without multiple updates to the DHT. For reconstruction of a replica after failure, the new replica retrieves the required number of fragments from healthy nodes and constructs a new linearly independent fragment as described above. The complete retrieval of data allows the new replica to participate in the data retrieval. To communicate its presence to the other replicas, the block contents are updated and the new replica can now seamlessly integrate into the replica set.

Another design issue relates to block retrieval performance. Reading stored encoded data involves at least two lookups in the DHT, one to find the object metadata, and a second one to get the list of nodes in the replica set. The lookups can be reduced by using a combination of metadata caches and optimistic block retrieval. A high degree of spatial locality in nodes accessing objects can be expected. That is, the node that has stored the data is most likely to retrieve it again. A hit in this cache eliminates all lookups in the DHT, and the performance then comes close to that of a traditional client-server system. On a miss, the client must perform the full lookup.

Another design issue relates to optimizing resource utilization. Traditional peer-to-peer systems do not require additional CPU cycles at the forwarding nodes. This makes the bandwidth of each node the only resource constraint for participation in data forwarding. However, a system in accordance with the present invention uses the intermediate nodes not only for forwarding, but also for erasure encoding, thus leading to CPU overheads. Since fragments are anonymous and independent, the forwarding nodes can opportunistically encode the data when the CPU cycles are available. Otherwise, the data is simply forwarded, and the destination (replicas) must generate linearly independent fragments corresponding to the data received. While this is an acceptable solution, the CPU availability can be used as a constraint in tree construction leading to a forwarding tree that has enough resources to perform erasure coding.

Another design issue relates to generalized network coding. The embodiment described above utilized distribution of erasure encoded data using a single tree. In order to provide faster data distribution, an alternative embodiment could use multiple trees, where each tree independently distributes a portion or segment of the original data. A more general approach is to form a Directed Acyclic Graph (DAG) using the participating nodes, for example in a manner similar to that described in V. N. Padmanabhan et al, Distributing Streaming Media Content Using Cooperative Networking, in Proceedings of the 12^{th} International Workshop on NOSSDAV, pages 177-186, 2002. The general DAG based approach with encoding at intermediate nodes has two main advantages: (i) optimal distribution of forwarding load among participating nodes; and (ii) exploiting the available bandwidth resources in the underlying network using multiple paths between the source and replica set.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A distributed method for converting original data into a replica set comprising a plurality of unique replica fragments using a multicast tree of network nodes, said method comprising:
performing first level encoding by encoding at least a portion of said original data at at least one first level network node to generate at least one first level intermediate encoded data block; and
for each of a plurality of further encoding levels (n), performing n^{th} level encoding of at least one n-1 level intermediate encoded data block at at least one n^{th} level network node in said multicast tree to generate at least one n^{th} level intermediate encoded data block.

2. The method of claim 1 further comprising:
at a final encoding level, performing final level encoding of at least one n-1 level intermediate encoded data block to generate at least one unique replica fragment.

3. The method of claim 2 further comprising the step of:
storing said at least one unique replica fragment at a leaf node of said multicast tree.

4. The method of claim 3 wherein said leaf node performs said final level encoding.

5. The method of claim 1 wherein a unique replica fragment comprises a key for decoding said unique replica fragment into a portion of said original data.

6. The method of claim 1 further comprising the step of:
computing said multicast tree.

7. The method of claim 1 wherein said steps of encoding comprise erasure encoding.

8. A method for converting original data into a replica data set comprising a plurality of unique replica fragments, said method comprising:
performing first level encoding by encoding at least a portion of said original data at at least one network node to generate at least one first level intermediate encoded data block;
transmitting said at least one first level intermediate encoded data block to at least one other network node; and
performing second level encoding of said at least one first level intermediate encoded data block at said at least one other network node.

9. The method of claim 8 wherein said step of performing second level encoding generates at least one of said unique replica fragments.

10. The method of claim 9 wherein a unique replica fragment comprises a key for decoding said unique replica fragment into a portion of said original data.

11. The method of claim 8 wherein said step of performing second level encoding generates at least one second level intermediate encoded data block, said method further comprising:
transmitting said at least one second level intermediate encoded data block to at least one other network node; and
performing third level encoding of said at least one second level intermediate encoded data block.

12. The method of claim 11 wherein said step of performing third level encoding generates at least one of said unique replica fragments.

13. The method of claim 8 wherein said steps of encoding comprise erasure encoding.

14. A system for converting original data into a replica data set comprising a plurality of unique replica fragments, said system comprising:
a source node storing said original data set;
a plurality of leaf nodes for storing said unique replica fragments; and
a plurality of intermediate nodes;
said source node, plurality of leaf nodes, and plurality of intermediate nodes logically configured as a multicast tree;
said nodes configured to convert said original data into said unique replica fragments by performing distributed erasure encoding at a plurality of levels of said multicast tree.

15. The system of claim 14 wherein at least one of said leaf nodes is configured to receive an intermediate encoded data block and to further erasure encode said intermediate encoded data block to generate a unique replica fragment.

16. The system of claim 14 wherein at least one of said intermediate nodes is configured to receive an intermediate encoded data block and to further erasure encode said intermediate encoded data block.

17. The system of claim 14 wherein said unique replica fragments comprise a key for decoding said unique replica fragment into a portion of said original data.
